(19) United States
(12) Patent Application Publication
(10) Pub. No.: US 2005/0163945 A1
(43) Pub. Date: Jul. 28, 2005

(54) Image forming unit

(75) Inventor: Hideyuki Nakamura, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/043,111

(22) Filed: Jan. 27, 2005

(30) Foreign Application Priority Data
Jan. 28, 2004 (JP) P.2004-019366

(51) Int. Cl. B41M 5/40

(52) U.S. Cl. 428/32.52

(57) ABSTRACT

An image forming unit comprising: a thermal transfer material containing an image forming layer; an image receiving material; and a material to be transferred, onto which an image formed on the image receiving material by transferring the image forming layer onto the image receiving material is to be transferred by heat, wherein the image forming layer transferred onto the image receiving material has a surface energy of more than 24.0 mJ/m².

### FIELD OF THE INVENTION

The present invention relates to an image forming unit for forming a full color image with a high resolving power. In particular, the invention relates to an image forming unit which is useful for preparing a color proof (DDCP: direct digital color proof) or a mask image in the printing field by thermal transfer recording from digital image signals.

### BACKGROUND OF THE INVENTION

In the graphic art field, in general, for the purpose of checking errors or necessity of color correction in the color separation step before the final printing (actual printing jobs), a color proof is prepared from color separation films. The color proof is required to realize a high resolving power with which high reproducibility of an intermediate tone image is possible or to have performances such as high step stability. Also, in order to obtain a color proof closed to an actual printed matter, it is preferred to use substrates or pigments as coloring materials which are used in the actual printed matter as materials to be used for the color proof. Also, a demand for a dry process which does not use a developing solution is high as the method for preparing a color proof.

As the dry method for preparing a color proof, there is developed a recording system for preparing a color proof directly from digital signals with the spread of electronic system in the pre-printing step (pre-press field). Such an electronic system is especially aimed to prepare a color proof with a high image quality and generally reproduces a halftone dot image of 150 lines or more per inch. In order to record a proof having a high image quality from digital signals, it is preferred to use laser beam that can be modulated by digital signals and can stop down the recording light thinly as a recording head. For achieving this, the development of a recording material which exhibits high recording sensitivity against the laser beam and has a high resolving power with which halftone dots at a high definition can be reproduced becomes necessary.

As a recording material to be used in the transfer image forming method utilizing laser beam, there are disclosed a hot melt transfer sheet comprising a support having thereon a photothermal converting layer which absorbs laser beam to generate heat and an image forming layer having a pigment dispersed in a heat fusible component such as waxes and binders in this order (see JP-A-5-58045) and a thermal transfer sheet of an abrasion system comprising a support having thereon a photothermal converting layer containing a photothermal converting substance, a thermal release layer having a very thin thickness (from 0.03 to 0.3 μm) and an image forming layer containing a colorant in this order (see JP-A-6-219052).

These image forming methods have such advantages that a body to be transferred which is provided with an image receiving layer (adhesive layer) as an image receiving sheet material can be used and that a multicolor image can be easily obtained by transferring images having a varied color onto an image receiving sheet successively. Further, these image forming methods are useful for preparing a color proof (DDCP: direct digital color proof) having a large size such as A2 and B2 sizes.

In particular, in the package field, a thermal transfer type image forming unit in which a thermal transfer sheet containing a white pigment in an image forming layer is used in a white ground, and a multicolor image by thermal transfer sheets of other colors, which is formed on an image receiving layer, are transferred onto a sheet to be transferred such as a transparent plastic film can be used. However, a combination of an image forming layer with a sheet to be transferred, in which transfer of the image onto the sheet to be transferred can be carried out satisfactorily and stably is being demanded.

### SUMMARY OF THE INVENTION

The thermal transfer type image forming unit of the invention is aimed to solve the foregoing problems of the related art and to achieve the following objects: (1) it is possible to satisfactorily and stably undergo transfer of a multicolor image formed on an image receiving layer onto a material to be transferred (for example, an actual paper stock such as art (coated) paper, mat paper, and finely coated paper or a transparent plastic film used for package); (2) it is possible to undergo delicate texture drawing or reproduction of accurate white (high-key area) on a material to be transferred; (3) the thermal transfer material provides a clear hue which a pigment colorant originally possesses, namely a hue equal to a printed matter; and (4) even in the case where laser recording is performed with high energy using laser beam as multiple beams, it is possible to form an image having good image quality and stable transfer density on an image receiving material.

Specifically, the means for solving the foregoing problems are as follows.
(1) An image forming unit comprising: a thermal transfer material containing an image forming layer; an image receiving material; and a material to be transferred, onto which an image formed on the image receiving material by transferring the image forming layer onto the image receiving material is to be transferred by heat, wherein the image forming layer transferred onto the image receiving material has a surface energy of more than 24.0 mJ/m².
(2) The image forming unit as set forth above in (1), wherein the material to be transferred has a surface energy of more than 35.0 mJ/m².
(3) The image forming unit as set forth above in (1) or (2), wherein a substrate of the material to be transferred is polyethylene (PE), polypropylene (PP), or polyethylene terephthalate (PET).
(4) The image forming unit as set forth above in (1) or (2), wherein the material to be transferred has a light transmittance of 50% or more.
(5) The image forming unit as set forth above in any one of (1) to (4), which comprises a white image forming layer.

According to the invention, by specifying a surface energy of an image forming layer of a thermal transfer material, it becomes possible to satisfactorily and stably transfer a multicolor image on an image receiving material containing an image forming layer onto a material to be transferred by heat.

### BRIEF DESCRIPTION OF THE DRAWINGS

FIG. 1 (FIGS. 1A, 1B and 1C) is a drawing to explain an outline of the mechanism of image formation by thin film thermal transfer using laser.

### DESCRIPTION OF REFERENCE NUMERALS AND SIGNS

10: Material to be transferred

12: Support

14: Photothermal converting layer

16: Image forming layer

16′: Laser beam irradiated region

20: Image receiving material

22: Support for image receiving material

24: Image receiving layer

30: Laminate

### DETAILED DESCRIPTION OF THE INVENTION

The thermal transfer type image forming unit of the invention is characterized in that the surface energy of the image forming layer of the image receiving material after image printing, that is, the surface energy of the image forming layer opposing to the side of the surface which comes into contact with the image receiving material, is controlled to be more than 24.0 mJ/m², and preferably more than 24.5 mJ/m².

Also, according to the invention, when a material to be transferred having a surface energy of more than 35.0 mJ/m², and preferably more than 40 mJ/m² is used as a constructive element of the thermal transfer type image forming unit, a good transfer image is more surely obtained on the material to be transferred.

In the invention, the surface energy of the image forming layer on the image receiving after image printing is a numeral value of γa as measured in the following manner. Also, the surface energy of the material to be transferred can be measured according to this manner.

The surface energies of liquid and solid are expressed by the following expressions 1 and 2, respectively. On the other hand, there is a relationship of the following expression 3 obtained by combing the Fowkee's equation with the Young's equation among γad and γap, a contact angle θ when the solid surface is wetted with a liquid, and γLd and γLp of the liquid. Accordingly, by measuring the contact angle using two kinds of liquids whose γLd and γLp are known and solving the simultaneous equations of the expression 3 from these values, the γad and γap are determined, whereby the surface energy γa of the solid can be calculated.

In the invention, after humidity conditioning the surface of an image forming layer printed on an image receiving material to be measured overnight at 23° C. and 50% RH, the contact angle of the surface of the image forming layer was measured using a surface contact angle meter (CA-A Model Contact Angle Meter, manufactured by Kyowa Interface Science Co., Ltd.). Two kinds of water and CH₂I₂ (methylene iodide) were used as a measurement solvent, and the contact angle was respectively measured at five points, from which was determined an average value. Using this average value and the values of γL, γLd and γLp of each solvent, the surface energy γa of the surface of the image forming layer was calculated.
γL=γLd+γLp Expression 1
γa=γad+γap Expression 2
γL(1+cos θ)=2(γad·γLd)^{1/2}+(γap·γLp)^{1/2} Expression 3

γL: Surface energy of solvent

θ: Contact angle

γad: Dispersing component of surface energy of solid

γap: Polar component of surface energy of solid

γLd: Dispersing component of surface energy of solvent

γLp: Polar component of surface energy of solvent

TABLE 1

| Solvent | γLd (mJ/m²) | γLp (mJ/m²) |
|---|---|---|
| CH₂I₂ | 51 | 0 |
| H₂O | 21.8 | 51 |

The substrate of the material to be transferred is not particularly limited so far as it is at least satisfactory with respect to the surface energy of the image forming layer on the image receiving material after image printing. Examples thereof include metals (for example, aluminum), papers, and plastic films. Of these, plastic films are preferable; and specifically, polyethylene (PE), polypropylene (PP), and polyethylene terephthalate (PET) are preferable.

Also, in the package field, for example, in using a PET bottle, for the purpose of explicitly visually recognizing the contents of a commodity from other portion than the printed area, the light transmittance of the plastic film is preferably 50% or more, and more preferably 80% or more. In this case, it is preferable that a white solid image and a multicolor image are formed in this order on the material to be transferred.

The material to be transferred which is used in the package field of the invention is not limited to the foregoing transparent materials but may be aluminum which is used in cans or papers or paper-containing materials to be used in packages such as sacks of confectionery and containers of milk. In this case, when an image is formed on the material to be transferred, the white solid image may or may not be used.

The transfer of a recording image onto the material to be transferred is carried out by superimposing the image forming layer of the thermal transfer material and the image receiving layer of the image receiving material in the thermal transfer type image forming unit opposing to each other; transferring an energy irradiated region of the image forming layer onto the image receiving layer of the image receiving material using a thermal head or upon irradiation with laser beam, thereby recording an image; and superimposing the image receiving material after image printing and the material to be transferred, thereby retransferring the image onto the side of the material to be transferred by heat. As the image recording method, laser thermal transfer is preferable.

For the retransfer of the image onto the material to be transferred by heat, it is preferred to use a heat laminator.

The temperature of a heat roll material of the heat laminator is preferably from 70 to 150° C., and the linear pressure is from 1.0 to 10 kN/m.

Also, the coefficient of dynamic friction of the material of an insertion table of the heat laminator is preferably from 0.1 to 0.7, and the delivery speed is preferably from 15 to 50 mm/sec. The Vickers hardness of the heat roll material is preferably from 10 to 100.

For example, Laminator FPL760T or CA-680T, manufactured by Fuji Photo Film Co., Ltd. is preferably used as the heat laminator.

The thermal transfer type image forming unit of the invention can be constructed of a thermal transfer material of at least one color, an image receiving material, and a material to be transferred. The image forming unit of the invention includes preferably three or more, and more preferably five or more thermal transfer materials each having image forming layer having a different color from each other. In the case of three, the color of the image forming layers is yellow (Y), magenta (M) and cyan (C); and in the case of five, it is preferable that the color of the image forming layers is, for example, yellow (Y), magenta (M), cyan (C), black (K) and white (W). Besides, as the thermal transfer material, colors which cannot be expressed through the combination of process colors, green (G), orange (O), red (R), blue (B), gold (Go), silver (S), pink (P), and the like may be contained.

In the invention, it is preferable that at least one of the thermal transfer materials is of white. In this case, it is preferable that the image forming layer of the thermal transfer material is made of titanium oxide as the principal component of the pigment.

In the image forming layer which exhibits white, when the solid portion of the recording image of the image forming layer is measured using a visual filter, its reflection optical density (reflection OD) is preferably not more than 0.6, and more preferably not more than 0.4. This reflection OD is one obtained by measuring the solid image recorded on a transparent material to be transferred on a black backing and is, for example, measured by X-rite 938. When the reflection OD is small, the white is dense. That is, it is meant that hiding properties that unnecessary colors are hardly seen through the image formed on the material to be transferred, whereby only the image by thermal transfer can be clearly seen are high.

The image forming layer which exhibits white may contain only titanium oxide or may use other pigment jointly. Examples of the pigment which is used jointly include calcium carbonate and calcium sulfate. Of these, rutile type or anatase type titanium oxide is preferable, and anatase type titanium oxide is especially preferable.

The weight average particle size of the anatase type titanium oxide which is used in the image forming layer is preferably from 1 to 100 nm, and more preferably from 1 to 10 nm. The weight average particle size of the rutile type titanium oxide is preferably from 100 nm to 500 nm, and more preferably from 200 to 300 nm.

The thickness of the image forming layer of the thermal transfer material of at least one color which is used in the image forming unit of the invention, especially the thickness of the image forming layer for white is preferably not more than 2.0 μm, and more preferably not more than 1.5 μm.

In the invention, the method for forming a multicolor image using a laser thermal transfer type image forming unit includes a step of superimposing the image forming layer of the thermal transfer material and the image receiving layer of the image receiving material opposing to each other and irradiating the laminate with laser beam, thereby transferring a laser beam irradiated region of the image forming layer onto the image receiving layer of the image receiving material; and a step of retransferring the transferred image onto a material to be transferred.

In the step of recording the image, the order of using the thermal transfer material is not particularly limited. In the case where a thermal transfer material for white is used, and a multicolor image is formed on a transparent material to be transferred, by finally using the thermal transfer material for white, i.e., by successively superimposing color images of a color other than white on the image receiving layer and providing, a white solid image on the uppermost layer the uppermost layer and the transparent material to be transferred are superimposed, whereby it becomes possible to retransfer the multicolor image onto the transparent material to be transferred together with the image receiving layer. Thus, a clear multicolor image can be seen, and therefore, such is preferable and effective for package.

Now, in the thus formed thermal transfer image, since the dot shape is sharp, thin lines of fine characters can be disinctly reproduced. Heat generated by the laser beam is transferred into the transfer interface without causing diffusion in the plane direction, whereby the image forming layer is sharply broken at the interface between the heating area and the non-heating area. For this reason, the thin film formation of the photothermal converting layer and the dynamic characteristics of the image forming layer in the thermal transfer material are controlled.

According to the simulation, it is estimated that the photothermal converting layer instantaneously reaches about 700° C., and therefore, when the film is thin, deformation or breakage is liable to occur. When the deformation or breakage occurs, there are caused such actual damages that the photothermal converting layer is transferred onto the image receiving material together with the transfer layer and that the transferred image becomes non-uniform. On the other hand, in order to obtain a prescribed temperature, the photothermal converting substance must be present in a high concentration in the film, resulting in problems such as deposition or migration of coloring matters into the adjacent layer.

For this reason, it is preferred to process the photothermal converting layer into a thin film of not more than about 0.5 μm by selecting an infrared absorbing coloring matter having excellent photothermal conversion characteristics and a heat resistant binder such as polyimide based binders.

Also, in general, when the deformation of the photo-thermal converting layer occurs, or the image forming layer per se is deformed due to high heat, the image forming layer transferred onto the image receiving layer causes unevenness in the thickness corresponding to a subsidiary scanning pattern of the laser beam so that the image becomes non-uniform, leading to a lowering of the apparent transfer density. This tendency becomes remarkable when the thickness of the image forming layer is thin. On the other hand, when the thickness of the image forming layer is thick, the sharpness of dots is deteriorated, and the sensitivity is lowered.

In order to cope with the both conflicting performances, it is preferred to improve the transfer unevenness by adding a low melting substance such as waxes to the image forming layer. Also, by adding an inorganic fine particle in place of the binder to properly increase the layer thickness such: that the image forming layer is sharply broken at the interface between the heating area and the non-heating area, it becomes possible to improve the transfer unevenness while keeping the sharpness of dots and sensitivity.

Also, in general, when the coating layer of the thermal transfer material absorbs moisture, the dynamic properties and thermal properties of the layer are changed, whereby temperature and relative humidity dependency of the recording circumstance is generated.

For the purpose of making the temperature and relative humidity dependency low, it is preferable that the coloring matter/binder system of the photothermal converting layer and the binder system of the image forming layer are an organic solvent system.

When the infrared absorbing coloring matter migrates from the photothermal converting layer into the image forming layer, for the purpose of preventing changes of the hue from occurring, it is preferred to design the photothermal converting layer by a combination of an infrared absorbing coloring matter having a strong holding power and a binder as described previously.

The image receiving material and the thermal transfer material are held on a drum by vacuum adhesion. This vacuum adhesion is important because the image is formed by controlling an adhesive force between the both materials, and therefore, the image transfer behavior is very sensitive to a clearance between the image receiving layer surface of the image receiving material and the image forming layer surface of the transfer material. When the clearance between the materials is widened with foreign matters such as wastes as a start, image deficiency or image transfer unevenness is caused.

In order to prevent such image deficiency or image transfer unevenness from occurring, it is preferable that uniform irregularities are provided on the thermal transfer or image receiving material, thereby obtaining a uniform clearance.

As a method for providing irregularities, there are in general a post treatment such as an embossing treatment and addition of a matting agent to the coating layer. For the purposes of simplifying the production step and stabilizing the material with a lapse of time, the addition of a matting agent is preferable.

For the sake of surely reproducing sharp dots as described previously, the side of the recording device is also required to be designed with high accuracy. Specifically, ones described in paragraph (0027) of JP-A-2002-337468 are applicable, but it should not be construed that the invention is limited thereto.

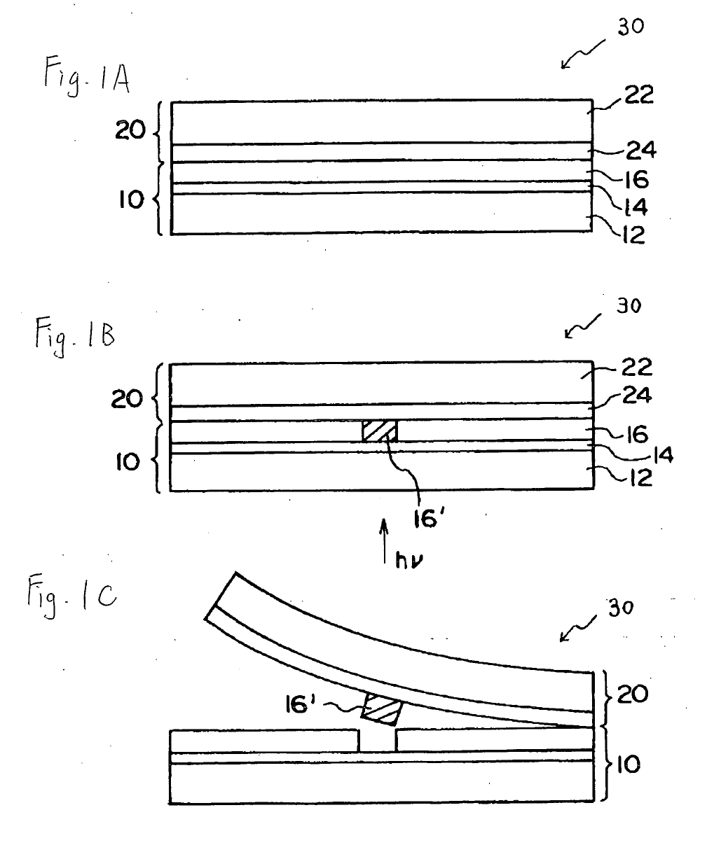

Next, an outline of the mechanism of multicolor image formation by thin film thermal transfer using laser will be described with reference to FIG. 1.

An image forming laminate 30 having an image receiving material 20 laminated on the surface of an image forming layer 16 of a thermal transfer material 10 is prepared. The thermal transfer material 10 has a support 12 having thereon a photothermal converting layer 14 and the image forming layer 16 in this order; the image receiving material 20 has a support 22 having thereon an image receiving layer 24; and the image receiving layer 24 is laminated such that it is brought into contact with the surface of the image forming layer 16 of the thermal transfer material 10 (FIG. 1A). When laser beam is imagewise irradiated in time sequence from the side of the support 12 of the thermal transfer material 10 of the laminate 30, a laser irradiated region 16′ of the photothermal converting layer 14 of the thermal transfer material 10 generates heat, whereby an adhesive force to the image forming layer 16 is lowered (FIG. 1B). Thereafter, when the image receiving material 20 and the thermal transfer material 10 are peeled apart from each other, the laser irradiated region 16′ of the image forming layer 16 is transferred onto the image receiving layer 24 of the image receiving material 20 (FIG. 1C).

With respect to the type, intensity, beam diameter, power, scanning speed and the like of the laser beam which is used in the light irradiation, specifically, ones described in paragraph (0041) of JP-A-2002-337468 are applicable, but it should not be construed that the invention is limited thereto.

As the method for forming a multicolor image, the multicolor image may be formed by repeatedly superimposing plural image layers (image forming layers having an image formed thereon) on the same image receiving material by using plural thermal transfer materials as described previously; and the multicolor image may be formed by once forming images on image receiving layers of plural image receiving materials and the transferring them onto a material to be transferred.

The thermal transfer recording using laser beam irradiation is not particularly limited with respect to the pigment and coloring matter at the time of transfer and/or changes of the state of the image forming layer so far as it is a method in which the laser beam is converted into heat, and a pigment-containing image forming layer is transferred onto the image receiving material by utilizing the resulting heat energy, thereby forming an image on the image receiving layer, and it includes any state of the solid state, the softened state, the liquid state, and the gaseous state. Of these, the solid state and/or the softened state is preferable. The thermal transfer recording using laser beam irradiation also includes, for example, conventionally known fusion type transfer, transfer by means of abrasion, and sublimation type transfer.

Of these, the thin film transfer type transfer, the fusion type transfer, and the abrasion type transfer are preferable at the point that an image having hue closed to a printed matter is prepared.

Also, for the sake of performing a step of transferring the image receiving material in which an image has been printed by the recording device onto the material to be transferred, a heat laminator is usually used as described previously. When the image receiving material and the material to be transferred are superimposed, to which are then applied heat and pressure, the both are bonded to each other; and thereafter, when the image receiving material is peeled apart from the material to be transferred, only the image receiving layer containing an image remains on the material to be transferred.

By connecting this device onto a plate making system, a system capable of revealing a function as a color proof is built up. In the system, it is necessary that a printed material having an image quality closed to a printed matter outputted from a certain plate making data as far as possible is outputted from the recording device. Then, there is required a software for making colors and halftone dots closed to the printed matter. With respect to the specific system connection, for example, ones described in paragraph (0049) of JP-A-2002-337468 are employable, but it should not be construed that the invention is limited thereto.

The thermal transfer material and the image receiving material to be suitably used in the recording device of this system will be described below.

[Thermal Transfer Material]

The thermal transfer material comprises a support having thereon at least a photothermal converting layer and an image forming layer and further comprises other layers, if desired.

(Support)

A material to be used for the support of the thermal transfer material is not particularly limited, and various support materials can be used depending upon the purpose. Specifically, ones described in paragraph (0051) of JP-A-2002-337468 are employable, but it should not be construed that the invention is limited thereto.

The support of the thermal transfer material may be subjected to a surface activating treatment and/or provided with one or two or more of undercoat layers for the purpose of enhancing adhesion to the photothermal converting layer which is provided on the support. Examples of the surface activating treatment include a glow discharge treatment and a corona discharge treatment. As a material of the undercoat layer, materials exhibiting high adhesiveness to the both surfaces of the support and the photothermal converting layer, having tow heat conductivity and having excellent heat resistance are preferable. Examples of such materials include styrene, styrene-butadiene copolymers, and gelatin. The thickness of the whole of the undercoat layer is usually from 0.01 to 2 μm. Also, if desired, the surface of the thermal transfer material opposing to the side on which the photothermal converting layer is provided may be provided with various functional layers such as an antireflection layer and an antistatic layer or may be subjected to a surface treatment. Specifically, a back layer described in paragraph (0053) of JP-A-2002-337468 is employable, but it should not be construed that the invention is limited thereto.

(Photothermal Converting Layer)

The photothermal converting layer contains a photo-thermal converting substance and a binder and optionally a matting agent. Further, the photothermal converting layer contains other components, if desired.

The photothermal converting substance is a substance having a function to convert irradiated light energy into heat energy. In general, this substance is a coloring matter capable of absorbing laser beam (inclusive of a pigment, hereinafter the same). In the case of performing image recording by infrared laser, it is preferred to use an infrared absorbing coloring matter as the photothermal converting substance. Examples of the coloring matter include black pigments (for example, carbon black), pigments of large cyclic ketone compounds having absorption in the visible light to near infrared region (for example, phthalocyanine and naphthalocyanine), organic dyes to be used as a laser absorbing material for high-density laser recording such as optical discs (for example, cyanine dues such as indolenine dyes, anthraquinone based dyes, azulene based coloring matters, and phthalocyanine based dyes), and organometallic compound coloring matters (for example, dithiol nickel complexes). Of these, since cyanine based coloring matters exhibit a high extinction coefficient against light in the infrared region, when they are used as the photothermal converting substance, it is possible to make the photothermal converting layer thin. As a result, it becomes possible to more enhance the recording sensitivity of the thermal transfer material. Accordingly, the cyanine based coloring matters are preferable.

As the photothermal converting substance, besides the coloring matters, inorganic materials such as particulate metallic materials such as blackened silver.

As the binder to be contained in the photothermal converting layer, for example, ones described in paragraph (0062) of JP-A-2002-337468 are preferable, and polyimide resins and polyamide-imide resins are especially preferable.

As the mat particle to be contained in the photothermal converting layer, for example, ones described in paragraph (0074) of JP-A-2002-337468 are preferable, and silica and silicon resin particles are especially preferable.

The particle size of the matting agent is usually from 0.3 to 30 μm, and preferably from 0.5 to 20 μm, and the addition amount of the matting agent is preferably from 0.1 to 100 mg/m².

Further, if desired, a surfactant, a thickener, an antistatic agent, and the like may be added in the photothermal converting layer.

The photothermal converting layer can be provided by dissolving the photothermal converting substance and the binder and further adding the matting agent and other components, if desired, to prepare a coating liquid and coating the coating liquid on the support, followed by drying.

The thickness of the photothermal converting layer is preferably from 0.03 to 1.0 μm, and more preferably from 0.05 to 0.5 μm. Also, when the photothermal converting layer has an optical density of from 0.80 to 1.26 against light having a wavelength of 808 nm, the transfer sensitivity of the image forming layer is enhanced, and therefore, such is preferable. It is more preferable that the photothermal converting layer has an optical density of from 0.92 to 1.15 against light having a wavelength of 808 nm.

(Image Forming Layer)

The image forming layer contains at least a pigment which is transferred onto the image receiving material to form an image and a binder and can further contain other components.

In general, the pigment is roughly classified into an organic pigment and an inorganic pigment. Since the former is especially excellent with respect to the transparency of a coating film, and the latter is generally excellent with respect to the hiding properties, the pigment may be adequately selected depending upon the application. In the case where the thermal transfer material is used for print color correction, organic pigments which are coincident with or closed in color tones to yellow, magenta, cyan and black generally used for printing inks are used. Specifically, ones described in paragraph (0080) of JP-A-2002-337468 are employable, but it should not be construed that the invention is limited thereto. Also, in the package field, as described previously, inorganic pigments corresponding to the white ink can be used. Besides, there may be the case of using a metal powder, a fluorescent pigment, etc. for the purpose of realizing a metallic color tone.

The mean particle size of the pigment is preferably from 0.03 to 1 μm, and more preferably from 0.05 to 0.5 μm.

As the binder of the image forming layer, specifically, ones described in paragraph (0085) of JP-A-2002-337468 are employable, but it should not be construed that the invention is limited thereto.

The image forming layer can contain the following components (1) to (3).

(1) Wax:

As the wax, specifically, ones described in paragraph (0087) of JP-A-2002-337468 are employable, but it should not be construed that the invention is limited thereto.

(2) Plasticizer:

As the plasticizer, specifically, ones described in paragraph (0090) of JP-A-2002-337468 are employable, but it should not be construed that the invention is limited thereto.

As a measure for increasing the surface energy of the image forming layer (24.0 mJ/m² or more), for example, an increase of the addition amount of rosin is enumerated. Besides, it is effective to blend a binder having a high surface energy, and examples of such a binder include polyvinyl alcohol, polymethyl acrylates, and nylons.

The addition amount of rosin is preferably 4% by weight or more and preferably 30% by weight or less in the total solid content of the image forming layer. When the addition amount of rosin is 30% by weight or less, sticky feeling develops or slipping property is not deteriorated, thus improper transportation is not caused. Moreover, melt viscosity does not reduce, the toner layer is not subjected to cohesive failure whereby the transfer mode is not one similar to melt transfer, different from on/off-type based on thin film separation, which does not result in the deterioration of text image quality.

Also, an addition amount of polyvinyl alcohol, an addition amount of polymethyl acrylates, and, an addition amount of nylons are each preferably 4% by weight or more and preferably 30% by weight or less in the total solid content of the image forming layer.

(3) Others:

In addition to the foregoing components, the image forming layer may further contain a surfactant, an inorganic or organic fine particle (for example, metal powders and silica gel), an oil (for example, linseed oil and mineral oils), a thickener, an antistatic agent, and the like.

The image forming layer can be provided by dissolving or dispersing the pigment and the binder, etc. to prepare a coating liquid and coating the coating liquid on the photothermal converting layer (in the case where the following heat-sensitive release layer is provided on the photothermal converting layer, the coating liquid is coated on the release layer), followed by drying.

On the photothermal converting layer of the thermal transfer material, it is possible to provide a heat-sensitive release layer containing a heat-sensitive material which generates a gas or releases adhered water by the action of heat generated on the photothermal converting layer, thereby weakening the bonding strength between the photothermal converting layer and the image forming layer. As such a heat-sensitive material, compounds which are decomposed or denatured themselves by heat to generate a gas (inclusive of polymers or low molecular compounds), compounds which absorb or adsorb a considerable amount of a readily volatile gas such as moisture (inclusive of polymers or low molecular compounds), and the like can be used. These materials can be used jointly.

As the polymers which are decomposed or denatured by heat to generate a gas, specifically, ones described in paragraph (0097) of JP-A-2002-337468 are employable, but it should not be construed that the invention is limited thereto.

In the case where a low molecular compound is used as the heat-sensitive material of the heat-sensitive release layer, a combination with the binder is desired. As the binder, polymers which are decomposed or denatured themselves by heat to generate a gas can be used, but usual binders which do not have such a nature can also be used. It is desired that the heat-sensitive release layer covers substantially entirely the photothermal converting layer. The thickness of the heat-sensitive release layer is generally in the range of from 0.03 to 1 μm, and preferably from 0.05 to 0.5 μm.

In the thermal transfer material, a photothermal converting layer having such a construction that it functions as both the photothermal converting layer and the heat-sensitive release layer may be formed by adding the heat-sensitive material to a coating liquid for photothermal converting layer in place of providing an independent heat-sensitive release later.

Next, the image receiving material which can be used in combination with the thermal transfer material will be described below.

[Image Receiving Material]

(Layer Construction)

The image receiving material is usually constructed such that at least one image receiving layer is provided on a support and that one or two or more layers of a cushioning layer, a release layer, and an interlayer are provided between the support and the image receiving layer, if desired. Also, the case where a back layer is present on the surface of the support opposing to the side of the image receiving layer is preferable in view of delivery properties.

(Support)

The support is not particularly limited, and examples thereof include usual substrates in the sheet like form, such as plastics, metals, glasses, resin-coated papers, papers, and various composites. Specifically, ones described in paragraph (0102) of JP-A-2002-337468 are employable, but it should not be construed that the invention is limited thereto.

The thickness of the support of the image receiving material is usually from 10 to 400 μm, and preferably from 25 to 200 μm. Also, the surface of the support may be subjected to a surface treatment such as a corona discharge treatment and a glow discharge treatment for the purpose of enhancing adhesion to the image receiving layer (or the cushioning layer) or adhesion to the image forming layer of the thermal transfer material.

(Image Receiving Layer)

For the purpose of transferring the image forming layer onto the surface of the image receiving material and fixing it thereto, it is preferred to provide at least one image receiving layer on the support. For the image receiving layer, specifically, ones described in paragraph (0106) of JP-A-2002-337468 are employable, but it should not be construed that the invention is limited thereto.

(Other Layers)

A cushioning layer may be provided between the support and the image receiving layer. By providing the cushioning layer, it becomes possible to enhance adhesion between the image forming layer and the image receiving layer at the time of laser thermal transfer and to enhance the image quality. Also, even when a foreign matter is incorporated between the thermal transfer material and the image receiving material at the time of recording, a gap between the image receiving layer and the image forming layer becomes small by the action of deformation-of the cushioning layer. As a result, it becomes possible to make the image deficient size such as deletion small. Further, in the case where after transferring and forming an image, the image is transferred onto a separately prepared material to be transferred, the image receiving surface is deformed corresponding to the paper irregular surface. Accordingly, it is possible to enhance transfer properties of the image receiving layer. Also, by lowering the gloss of the material to be transferred, it becomes possible to enhance approximation to the printed matter.

For the cushioning layer, specifically, ones described in paragraph (0112) of JP-A-2002-337468 are employable, but it should not be construed that the invention is limited thereto.

Though the image receiving layer and the cushioning layer must be bonded to each other until the stage of laser recording, in order to transfer an image onto the material to be transferred, it is preferable that the both layers are provided such that they can be peeled apart from each other. In order to facilitate the peeling, it is preferred to provide a release layer in a thickness of from approximately 0.1 to 2 μm between the cushioning layer and the image receiving layer. When the thickness of the release layer is too thick, the performance of the cushioning layer difficultly appears, and therefore, it becomes necessary to adjust the thickness of the release layer depending upon the kind of the release layer.

For the release layer, specifically, ones described in paragraph (0114) of JP-A-2002-337468 are employable, but it should not be construed that the invention is limited thereto.

The image receiving material to be combined with the thermal transfer material may be constructed such that the image receiving layer also functions as a cushioning layer. In that case, the image receiving material may be of a support/cushioning image receiving layer construction or a support/undercoat layer/cushioning image receiving layer construction. In this case, it is preferable that the cushioning image receiving layer is provided releasably such that retransfer onto the material to be transferred is possible. In this case, the image after retransfer onto the material to be transferred is an image having excellent gloss.

The thickness of the cushioning image receiving layer is from 5 to 100 μm, and preferably from 10 to 40 μm.

Also, when a back layer is provided on the surface of the support opposing to the side of the surface on which the image receiving layer is provided, the delivery properties of the image receiving material become good, and therefore, such is preferable. In view of improving the delivery properties within the recording device, it is preferred to add a surfactant, an antistatic agent comprising a tin oxide fine particle, etc., and a matting agent comprising silicon oxide, a PMMA particle, etc. to the back layer.

These additives can be added to other layers than the back layer, if desired. The kind of the additives cannot be unequivocally defined depending upon the purpose, but for example, in the case of a matting agent, a particle having a mean particle size of from 0.5 to 10 μm can be added in an amount of from approximately 0.5 to 80% in the layer. The antistatic agent can be adequately selected and used among various surfactants and conductive agents such that the surface resistance of the layer preferably becomes not more than 10¹² Ω, and more preferably not more than 10⁹ Ω under conditions at 23° C. and 50% RH.

For the back layer, specifically, ones described in paragraph (0119) of JP-A-2002-337468 are employable, but it should not be construed that the invention is limited thereto.

The thermal transfer material and the image receiving material can be utilized for image formation as a laminate in which an image forming layer of the thermal transfer material and an image receiving layer of the image receiving material are superimposed.

The laminate of the thermal transfer material and the image receiving material can be formed by various methods. For example, it can be easily obtained by superimposing an image forming layer of the thermal transfer material and an image receiving layer of the image receiving material and passing the laminate between pressure heat rolls. In this case, the heating temperature is not higher than 160° C., and preferably not higher than 130° C.

As another method for obtaining the laminate, the foregoing vacuum adhesion method is suitably employed, too.

### EXAMPLES

The invention will be described below with reference to the following Examples, but it should not be construed that the invention is limited. In the following description, the term “part” means “part by weight” unless otherwise indicated.

### Example 1

-Preparation of Thermal Transfer Material W (White)-

[Formation of Back Layer]

[Preparation of coating liquid for first back layer]

| | | |
|---|---|---|
| Aqueous dispersion of acrylic resin (Jurymer | 2 | parts |
| ET410, manufactured by Nihon Junyaku Co., Ltd., | | |
| solids content: 20% by weight): | | |
| Antistatic agent (aqueous dispersion of tin | 7.0 | parts |
| oxide-antimony oxide) (mean particle size: 0.1 | | |
| μm, 17% by weight): | | |
| Polyoxyethylene phenyl ether: | 0.1 | parts |
| Melamine compound (Sumitex Resin M-3, | 0.3 | parts |
| manufactured by Sumitomo Chemical Co., Ltd.): | | |

| | |
|---|---|
| Distilled water: | To make 100 |
| | parts in total |

[Formation of First Back Layer]

One surface (back surface) of a biaxially stretched polyethylene terephthalate support having a thickness of 75 μm (the both surfaces of which had an Ra of 0.01 μm) was subjected to a corona treatment, and the coating liquid for first back layer was coated in a dry layer thickness of 0.03 μm, followed by drying at 180° C. for 30 seconds to form a first back layer.

[Preparation of coating liquid for second back layer]

| | | |
|---|---|---|
| Polyolefin (Chemipearl S-120, manufactured by | 3.0 | parts |
| Mitsui Chemicals, Inc., 27% by weight): | | |
| Antistatic agent (aqueous dispersion of tin | 2.0 | parts |
| oxide-antimony oxide) (mean particle size: 0.1 | | |
| μm, 17% by weight): | | |
| Colloidal silica (Snowtex C, manufactured by | 2.0 | parts |
| Nissan Chemical Industries, Ltd., 20% by weight): | | |
| Epoxy compound (Denacol EX-614B, manufactured | 0.3 | parts |
| by Nagase Kasei Kogyo Co., Ltd.): | | |

| | |
|---|---|
| Distilled water: | To make 100 |
| | parts in total |

[Formation of Second Back Layer]

The coating liquid for second back layer was coated in a dry layer thickness of 0.03 μm on the first back layer, followed by drying at 170° C. for 30 seconds to form a second back layer.

<Formation of Photothermal Converting Layer>

[Preparation of Coating Liquid for Photothermal Converting Layer]

The following respective components were mixed while stirring using a stirrer to prepare a coating liquid for photothermal converting layer.

[Composition of Coating Liquid for Photothermal Converting Layer]

| | | |
|---|---|---|
| Infrared absorbing coloring matter having the | 4.85 | parts |
| following structure: | | |

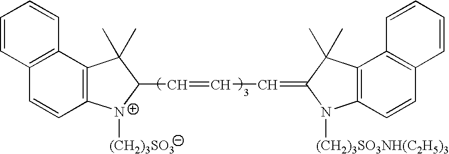

| | | |
|---|---|---|
| Polyamide-imide resin (15% N-methyl- | 179.2 | parts |
| pyrrolidone solution) (Vylomax HR-11N, | | |
| manufactured by Toyobo Co., Ltd.): | | |
| 1.5 μm-Silicone particle (Tospearl 120, | 1.11 | parts |
| manufactured by GE Toshiba Silicones): | | |
| Polyvinylpyrrolidone-styrene copolymer | 3.41 | parts |
| (Antara 430, manufactured by ISP): | | |
| N-Methylpyrroplidone (NMP): | 1,023 | parts |
| Methyl ethyl ketone: | 685.5 | parts |
| Methanol: | 97.93 | parts |
| Surfactant (Megafac F-780F, manufactured by | 0.23 | parts |
| Dainippon Ink and Chemicals, Incorporated, | | |
| which is a fluorine based surfactant): | | |

[Formation of Photothermal Converting Layer on the Surface of Support]

The foregoing coating liquid for photothermal converting layer was coated on one surface of a polyethylene terephthalate film (support) having a thickness of 75 μm using a wire bar and then dried in an oven at 120° C. for 2 minutes to form a photothermal converting layer on the support. The optical density (OD) of the resulting photothermal converting layer was measured at a wavelength of 808 nm using a UV spectrophotometer UV-240, manufactured by Shimadzu Corporation and found to be 1.48. The thickness was measured by observing the cross section of the photothermal converting layer by a scanning electron microscope and found to be 0.5 μm in average.

<Formation of Image Forming Layer on the Surface of Photo-Thermal Converting Layer>

The following coating liquid for white image forming layer was coated on the surface of the foregoing photothermal converting layer for one minute using a wire bar and then dried in an oven at 100° C. for 2 minutes to form a white image forming layer on the photothermal converting layer.

The resulting thermal transfer material W had a thickness of the image forming layer of 1.50 μm.

[Composition of white pigment dispersion mother liquid]

| | | |
|---|---|---|
| Polyvinyl butyral (S-Lex B BL-SH, manufactured | 2.65 | parts |
| by Sekisui Chemical Co., Ltd.): | | |
| Rutile type titanium oxide (JR805, | 35.0 | parts |
| manufactured by Tayca Corporation, weight | | |
| average particle size: 0.29 μm): | | |
| Dispersing agent (Solsperse 20000, | 0.35 | parts |
| manufactured by Avecia Limited): | | |
| n-Propyl alcohol: | 62.0 | parts |

[Composition of coating liquid for white image forming layer]

| | | |
|---|---|---|
| White pigment dispersion mother liquid as | 1,203 | parts |
| described previously | | |
| 2,5-Bis[2-(5-t-butylbenzoxazolyl)]thiophene | 2.77 | parts |
| (Uvitex OB, manufactured by Ciba Specialty | | |
| Chemicals): | | |
| Wax based compounds: | | |
| (Stearic amide, Neutron 2, manufactured by | 5.72 | parts |
| Nippon Fine Chemical Co., Ltd.): | | |
| (Behenic amide, Diamid BM, manufactured by | 5.72 | parts |
| Nippon Kasei Chemical Co., Ltd.): | | |
| (Lauric amide, Diamid Y, manufactured by Nippon | 5.72 | parts |
| Kasei Chemical Co., Ltd.): | | |
| (Palmitic amide, Diamid KP, manufactured by | 5.72 | parts |
| Nippon Kasei Chemical Co., Ltd.): | | |
| (Erucic amide, Diamid L-200, manufactured by | 5.72 | parts |
| Nippon Kasei Chemical Co., Ltd.): | | |
| (Oleic amide, Diamid O-200, manufactured by | 5.72 | parts |
| Nippon Kasei Chemical Co., Ltd.): | | |
| Rosin (KE-311, manufactured by Arakawa | 80.34 | parts |
| Chemical Industries, Ltd.) (Components: resin | | |
| acid, 80 to 97%; resin acid components: abietic | | |
| acid, 30 to 40%; neoabietic acid, 10 to 20%; | | |
| dihydroabietic acid, 14%; tetrahydroabietic | | |
| acid, 14%): | | |
| Surfactant (Megafac F-780F, manufactured by | 15.96 | parts |
| Dainippon Ink and Chemicals, Incorporated, | | |
| solids content: 30%): | | |
| n-Propyl alcohol: | 1,587 | parts |
| Methyl ethyl ketone: | 577.1 | parts |

In Example 1, the amount of rosin was 13.9% by weight in the total solid content of the white image forming layer.

-Preparation of Image Receiving Material-

A coating liquid for cushioning layer and a coating liquid for image forming layer having the following composition, respectively were prepared.

| (1) Coating liquid for cushioning layer: | | |
|---|---|---|
| Vinyl chloride-vinyl acetate copolymer | 20 | parts |
| (principal binder) (Solbine CL2, manufactured | | |
| by Nissin Chemical Industry Co., Ltd.): | | |
| Plasticizer (Paraplex G-40, manufactured by CP | 10 | parts |
| HALL. COMPANY): | | |
| Surfactant (Fluorine based surfactant: coating | 0.5 | parts |
| auxiliary) (Megafac F-178K, manufactured by | | |
| Dainippon Ink and Chemicals, Incorporated): | | |
| Methyl ethyl ketone: | 60 | parts |
| Toluene: | 10 | parts |
| N,N-Dimethylformamide: | 3 | parts |
| (2) Coating liquid for image receiving layer: | | |
| Polyvinyl butyral (S-Lex B BL-SH, manufactured | 8 | parts |
| by Sekisui Chemical Co., Ltd.): | | |
| Antistatic agent (Sanstat 2012A, manufactured | 0.7 | parts |
| by Sanyo Chemical Industies, Ltd.): | | |
| Surfactant (Megafac F-476, manufactured by | 0.1 | parts |
| Dainippon Ink and Chemicals, Incorporated): | | |
| n-Propyl alcohol | 20 | parts |
| Methanol: | 20 | parts |
| 1-Methoxy-2-propnal: | 50 | parts |

The foregoing coating liquid for cushioning layer was coated on a white PET support (Lumirror #130E58, manufactured by Toray Industries, Inc., thickness: 130 μm) using a coating machine for small width, the coated layer was dried, and the coating liquid for image receiving layer was subsequently coated, followed by drying. The coating amounts were adjusted such that after drying, the layer thickness of the cushioning layer and the image receiving layer was about 20 μm and about 2 μm, respectively. The resulting material was used for image recording using laser beam in the following manner.

-Formation of Transferred Image-

Using the foregoing image receiving material and cyan thermal transfer material, a white solid image was formed on the image receiving material using a laser thermal transfer printer, Luxel FINALPROOF 5600, manufactured by Fuji Photo Film Co., Ltd. This solid image had a surface energy of 28.2 mJ/m².

Further, the solid image and the image receiving layer were retransferred onto a transparent plastic film (Melinex M709 having a thickness of 50 μm, manufactured by Teijin DuPont Films Japan Limited) using a laminator FPL760T, manufactured by Fuji Photo Film Co., Ltd. Similarly, the retransfer was carried out using, as a material to be transferred, PET (thickness: 100 μm, manufactured by Fuji Photo Film Co., Ltd.), PE (thickness: 40 μm, manufactured by Okura Industrial Co., Ltd.), PP (thickness: 12 μm, manufactured by Oji Paper Co., Ltd.), Teflon (thickness: 125 μm, manufactured by Fuji Photo Film Co., Ltd.), and a hot laminated film (prepared by coating ethylene ethyl acrylate (EEA-709, manufactured by Du Pont-Mitsui Polychemicals Co., Ltd.) in a thickness of 15 μm on the surface of 100 μm-thick PET by melt extrusion), respectively.

### Example 2

A transfer material W was prepared in the same manner as in Example 1, except that in Example 1, the polyvinyl butyral in the white pigment dispersion mother liquid was replaced by rosin KE-311, and an image was retransferred onto the respective material to be transferred in the same manner as in Example 1. In Example 2, the amount of rosin was 19.4% by weight in the total solid content of the white image forming layer.

### Example 3

A transfer material W was prepared in the same manner as in Example 1, except that in Example 1, the amount of the polyvinyl butyral in the white pigment dispersion mother liquid was changed to 5.30 parts and that the amount of the rosin KE-311 in the coating liquid for white image forming layer was changed to 48.4 parts, and an image was retransferred onto the respective material to be transferred in the same manner as in Example 1. In Example 3, the amount of rosin was 9.3% by weight in the total solid content of the white image forming layer.

### Comparative Example 1

A transfer material W was prepared in the same manner as in Example 1, except that in Example 1, the amount of the polyvinyl butyral in the white pigment dispersion mother liquid was changed to 7.95 parts and that the amount of the rosin KE-311 in the coating liquid for white image forming layer was changed to 16.6 parts, and an image was retransferred onto the respective material to be transferred in the same manner as in Example 1. In Comparative Example 1, the amount of rosin was 3.4% by weight in the total solid content of the white image forming layer.

The resulting images were evaluated in the following manners. The results obtained are shown in Table 2.
D: The image is not transferred at all.
C: Intermediate evaluation between “D” and “B”.
B: Stripe-like deletion caused by non-transfer is partly observed in the solid portion or halftone dot portion.
A: Stripe-like deletion caused by non-transfer is not observed in the solid portion or halftone dot portion, and a good halftone dot shape is obtained.

The light transmittance of the material to be transferred was measured at a wavelength of 400 nm using a spectro-photometer UV-240, manufactured by Shimadzu Corporation.

TABLE 1

| | | | | | | Comparative |
|---|---|---|---|---|---|---|
| | | | Example 1 | Example 2 | Example 3 | Example 1 |
| Material to be transferred | | | Surface | Surface | Surface | Surface |
| | Surface | Light | energy of | energy of | energy of | energy of |
| | energy | transmittance | solid image | solid image | solid image | solid image |
| Kind | (mJ/m²) | (%) | (at 28.2 mJ/m²) | (at 41 mJ/m²) | (at 24.8 mJ/m²) | (at 23.8 mJ/m²) |
| Melinex | 42 | 86 | A | A | A | B |
| PET | 49 | 84 | A | A | A | C |
| PE | 35 | 68 | A | A | A | D |
| PP | 35.5 | 89 | A | A | A | D |
| Teflon | 20.1 | 84 | B | B | B | D |
| Hot laminated | 49 | 12 | A | A | A | C |
| film | | | | | | |

It is clear that the Examples of the invention are excellent with respect to the transfer properties of an image onto the material to be transferred as compared with Comparative Example 1.

This application is based on Japanese Patent application JP 2004-19366, filed Jan. 28, 2004, the entire content of which is hereby incorporated by reference, the same as if set forth at length.

1. An image forming unit comprising:
a thermal transfer material containing an image forming layer;
an image receiving material; and
a material to be transferred, onto which an image formed on the image receiving material by transferring the image forming layer onto the image receiving material is to be transferred by heat,
wherein the image forming layer transferred onto the image receiving material has a surface energy of more than 24.0 mJ/m².

2. The image forming unit according to claim 1, wherein the material to be transferred has a surface energy of more than 35.0 mJ/m².

3. The image forming unit according to claim 1, wherein the material to be transferred contains a substrate containing polyethylene, polypropylene, or polyethylene terephthalate.

4. The image forming unit according to claim 1, wherein the material to be transferred has a light transmittance of 50% or more.

5. The image forming unit according to claim 1, wherein the image forming layer is a white image forming layer.

6. The image forming unit according to claim 1, wherein the image forming layer contains at least one of polyvinyl alcohol, polymethyl acrylates, and nylons.

7. The image forming unit according to claim 1, wherein the thermal transfer material further contains a support and a photothermal converting layer so that the support, the photothermal converting layer and the image forming layer are provided in this order.
